(19) United States
(12) Patent Application Publication
(10) Pub. No.: US 2013/0204709 A1
(43) Pub. Date: Aug. 8, 2013

(54) METHOD AND APPARATUS FOR PROVIDING ADS ON WEBSITES TO WEBSITE VISITORS BASED ON BEHAVIORAL TARGETING

(71) Applicant: Val KATAYEV, Roslyn, NY (US)

(72) Inventor: Val KATAYEV, Roslyn, NY (US)

(21) Appl. No.: 13/367,442

(22) Filed: Feb. 7, 2012

(51) Int. Cl. G06Q 30/02

(52) U.S. Cl. 705/14.66

(57) ABSTRACT

An ad server provides very narrowly targeted ads from an ad campaign to the visitor of a website. The visitor has a known characteristic parameter, based for example on his musical preference. The ad is then selected that pertains to an advertising segment of interest to other visitors sharing the characteristic parameter.

### RELATED APPLICATIONS

None

### BACKGROUND OF THE INVENTION

a. Field of Invention

This invention pertains to a method and apparatus for presenting ads to a website visitor based on a profile obtained by behavioral profiles of other visitors sharing a characteristic parameter, such as a musical preference.

b. Description of the Prior Art

It is well known in the world of advertising that ads targeted to a very specific audience are most effective. One major advantage of advertising online as opposed to advertising using conventional media (such as ads billboards, newspapers, magazines, television, etc.) is that in many instances, a visitor to a website has a known profile and therefore the visitor can be presented with an ad that is correlated to the visitor, based on that profile. For example, a repeat visitor's interests may be known based on his behavior and interests from a previous visit. Behavioral profiles of visitors may also be obtained from other sources and used to select an appropriate ad for them.

However, in many instances very little may be known about a visitor to a website and therefore an ad server must be satisfied with presenting a generic ad to the visitor, or not to present an ad at all. Since the generic ad is not targeted to the visitor, it is inherently less effective.

### SUMMARY OF THE INVENTION

Briefly, this invention pertains to a computer-implemented method of profiling visitors based on cross referencing multiple data sources and utilizing such data to provide analytics and improved visitor targeting. The method includes data collection; cross referencing and enriching that collected data; analyzing the enriched data; reporting that data; and targeting visitors based on that data.

Data collection utilizes a primary source with structured content data on a given site that is accessible in real time. A secondary source can include but is not limited to behavioral data from an external server or internal survey data. For example, if the visitor visits a site with content (the primary source) pertaining to Lady Gaga, the visitor's characteristic profile is collected as “Lady Gaga.” Whenever secondary data is available for this visitor, it is paired with the primary data. The secondary data may consist of segments such as age, gender, shopping preferences, hobbies, and other behaviors.

The next step of the invention pertains to cross-referencing and enriching the collected data. As previously exampled, such Lady Gaga fans in mass can be cross-referenced with the secondary data to form estimations about their behavioral profile. At this point we can analyze this enriched data to extrapolate a correlation between content-based interests and visitor behaviors and store it in a profile database to be accessible for reporting. For ease of use, such extrapolated data is used to calculate interest indexes for all relationships between content-based interests and visitor behaviors. For example, a Lady Gaga fan may be more likely than the average visitor to shop for fashion online compared to the average visitor from the primary data source audience.

Once such correlations have been analyzed, the database can be reported and/or distributed. The reported data can be utilized along with the primary data sources to improve visitor targeting on the fly. Using the previous example, if a visitor on a web page with Lady Gaga content is seen at the primary data source, the reporting data can be used to target ads related to fashion shopping to that visitor.

### BRIEF DESCRIPTION OF THE FIGURES

FIG. 1 shows a block diagram of a system for presenting targeted ads to visitors of several websites in accordance with this invention;

FIG. 2 shows a flow chart for selecting an ad for a visitor to the system of FIG. 1;

FIG. 3 shows a Venn diagram showing the population of visitors of the content sites of FIG. 1 and the population of visitors with data available from secondary data source 32;

FIG. 4 shows a flow chart for generating the profile database from information obtained when visitors access the content sites of the system of FIG. 1;

FIGS. 5 and 6 show a typical concordance between preferences for various singers and various target segments.

### DETAILED DESCRIPTION OF THE INVENTION

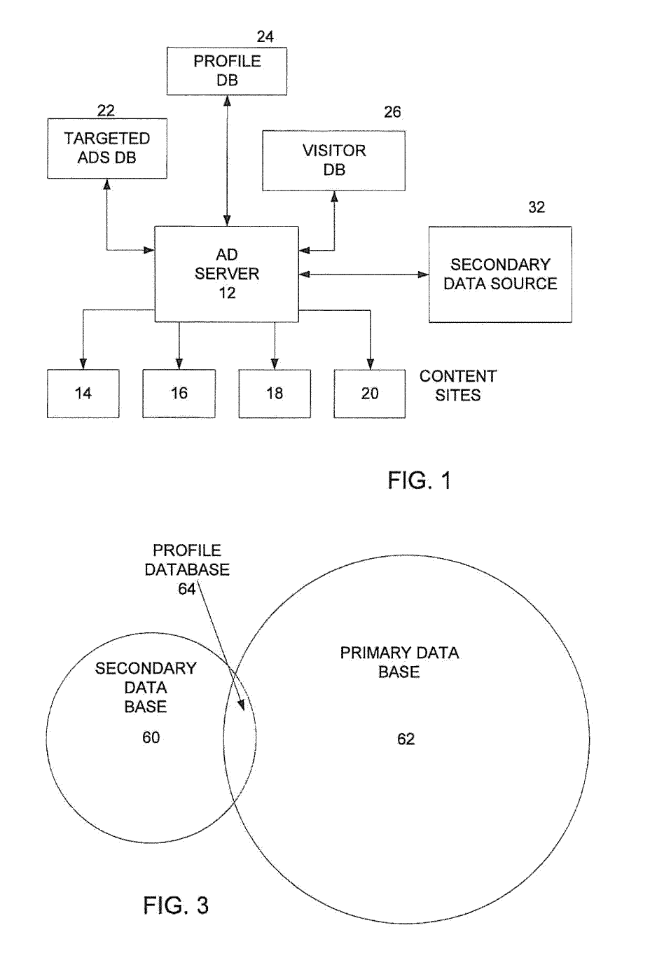

Referring first to FIG. 1, a system 10 constructed in accordance with this invention, includes an ad server 12. The ad server 12 is associated with one or more content sites 14-20. When a visitor is detected at the sites, the ad server 12 is notified it selects an appropriate or targeted ad for the visitor (as described in more details below) and sends this ad to the content site. Such ad may include but are not limited to standard banners, video, flash, etc. The content site then presents the ad to the visitor.

In order to perform these functions, ad server 12 is coupled to several databases, including a targeted ad database 22, a profile database 24 and a visitor database 26. The databases can be stored in a single memory or several memories.

The ad database 22 contains several targeted ads. Each targeted ad has specific length or duration, covers or is related to a certain service or product, and is targeted to a specific segment of the visitor population. The term segment is used to refer to a portion of all possible visitors to websites. The segment being selected for a particular visitor is based on any desired demographic criteria such as age, income, occupation, hobbies of the visitor etc.

The targeted ads may be individual ads that based on content, style, location, actors, etc., are separate and distinct from any other ads, or several ads may be part of an ad campaign designated for presentation to visitors during a specific time period of anywhere from several days to several weeks. An ad campaign may also include one or more ads directed at a geographic location. For example, a separate entity such as Sears, may provide one or more ads as part of a spring campaign, the ads showing various seasonal clothing articles designed for women between the ages of 18 and 21. A campaign may consist of showing these ads to the targeted visitors during the last two weeks of April. Other targeted ads in memory 22 pertain to other goods and services targeted at other audiences. One of the tasks of the ad server 12 is to identify one or more appropriate ads for each visitor of sites 14-20. This is accomplished as described in below in conjunction with the figures.

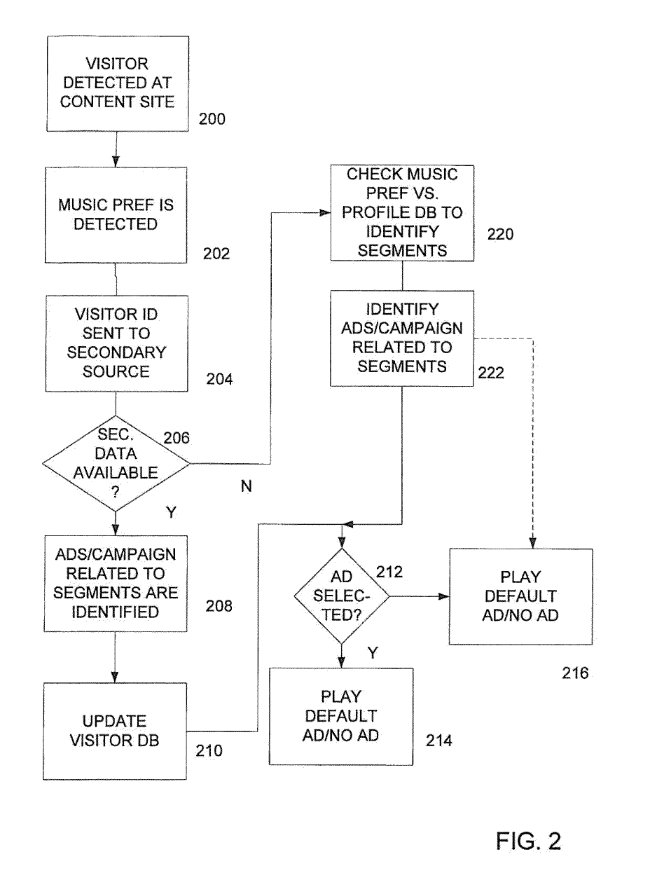

First, the ad server 12 monitors the visitors or (whether registered or not) to any one of the content sites 14-20 (step 200 in FIG. 2). Each of these sites provides various services, product information and/or other information to its visitors. For example, in one embodiment of the invention, the ad server 12 classifies all the visitors based on their musical preferences. In this case, the content sites 14-20 provide information related to music. For example, site 14 may be dedicated to classical music, site 16 may be dedicated to country music, site 18 may be related to rock music, etc.

Of course, in many cases, a single site may have several sections formed of one or more webpages, each section being dedicated to a particular music genre. In this case, information is collected not from several different distinct sites but from the webpages of a single site. In this case the content being viewed by the visitor on a specific page is monitored. For example, a web site may contain 500,000 lyrics from 20,000 artists. In the present invention, musical preferences of a visitor to a site are determined based on the particular page visited, such as the webpage related to Lady Gaga's “Bad Romance” lyrics.

The visitors arrive to these content sites by using a conventional search engine or by other well-known means.

In the illustrated embodiment, the characteristic parameter is the visitor's preference for a particular kind of content (e.g., classical, country or rock music) based on whether the visitor visits sites, 14, 16, 18 or 20 or a particular webpage at a particular site, e.g., the webpage with the lyrics of Lady Gaga's “Bad romance”, as discussed above. It has been found that it is helpful to make the characteristic parameter as granular as possible, based on the behavior of the visitor on the respective site. In other words, preferably, when the visitor is visiting the country music site, his characteristic parameter is not merely country music, but the song(s) or artist(s) that he shows interest in.

In the world of advertising, there are many segments of population that advertisers are typically interested, with some of the segments overlapping. These segments include several age ranges, geographic locations, income, sex, occupation, hobbies, sports activities, travel preferences, medical ailments, as well as specific on-line behavior, such as the propensity to shop online for clothing, books, electronics, and so on. Behavioral target profiles can be used to select ads targeted to specific population segments. Behavioral target profiles provide information correlating various segments having respective characteristic parameters with other interests. In the preferred embodiment, the behavioral target profiles are related to musical preferences. In other embodiments, profiles with other characteristic parameters are obtained. For example, a visitor may like sports, and more particularly he may be interested at one site in light weight racing bikes, and at another site he may express an interest in bike races for amateurs in France. In this case, the characteristic parameter is bike riding.

Returning to FIG. 2, the characteristic parameter of a particular visitor is detected in step 202, based on his content preference. In step 204, the visitor's ID (for example, his cookie) is checked against a secondary data source 32. (This step can be performed directly by appropriate software at the respective site, or by the ad server 12). The secondary data source 32 provides any visitor specific data that it has available which may indicate the segment that the visitor belongs to, or any other information, such as, this visitor likes cars, or this visitor has been looking for houses. Secondary sources are either available from third parties that may charge for this information or such information could be collected internally through surveys.

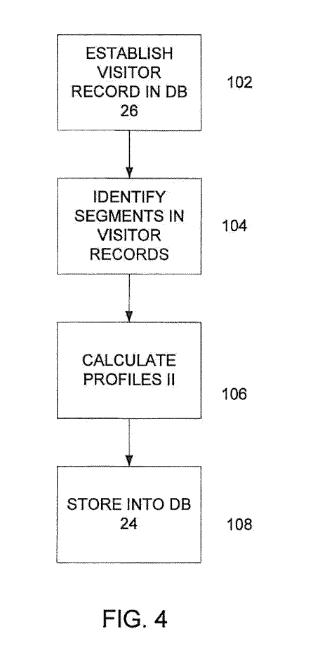

FIG. 3 shows a Venn diagram of a universe 60 of all visitors of various people that have visited these or other sites and for which there is some data available from the secondary data source 32, and universe 62 of all the visitors to the to the content sites 14-20. There is a set of visitors 64 that belong to both universes. That is, in this particular embodiment, there is a set 64 of visitors that have musical preferences and that are also found in the secondary database 32. The present inventors have found that typically, the set 64 includes about 10% or less of the visitors in universe 62.

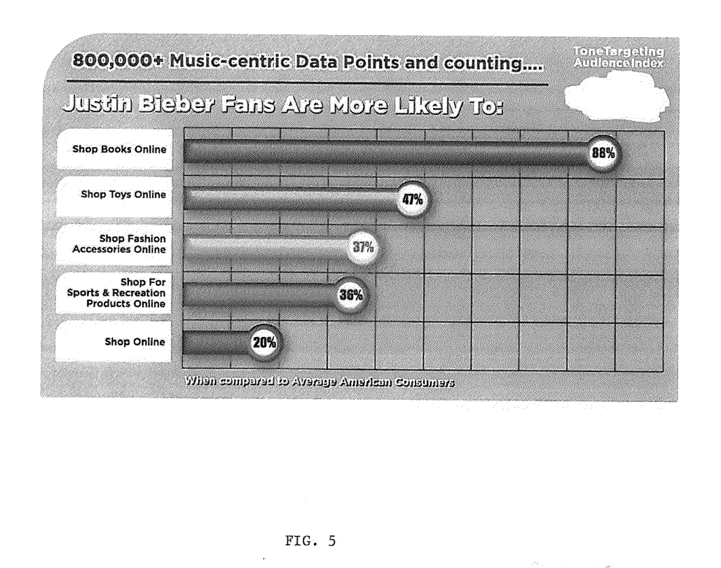

In step 206, a determination is made to check whether any secondary data available about the particular visitor V from the secondary data source 32. If there is, then in step 208, a visitor database 26 is updated, as described more fully below, in conjunction with FIG. 4.

In step 210, ad server 12 checks the on-going campaigns and other criteria and determines if there are any ads in the targeted ads database 22 that are targeted to the visitor, based on the content data. Once one or more suitable ads are identified, the selection of ads is narrowed further by taking in consideration several factors, such as: (1) does the ad conform to a flash protocol that matches the respective site (e.g., site 14); (2) is the visitor from a desired geographic area (if specified); (3) is the campaign including the ad currently active; (4) is the site 14 a desired site for the ad; (5) has visitor V seen the ad before; (6) is the visitor's video monitor resolution acceptable for the ad. It should be understood that not all the factors are applicable to all the ads and that these are just some of the factors that can be used to determine that the ad is accurately targeted. Other factors may be used as well.

In step 212 a check is performed to determine if any targeted ads are available that meets all these criteria. If one or more such ads are found, they are presented to visitor V in step 214.

If no targeted ads are found, then in step 216 a default, or generic ad is displayed. Alternatively, if no suitable targeted ad is found, no ad is presented to viewer V.

Returning to step 206, if no secondary data for visitor V is available, then in step 220, a profile database 24 is checked using the content preference of visitor V to identify one or more relevant segments for visitor V.

Moreover, once the profile database 24 has become sufficiently large so that it has information for a large percentage of the population of visitors (as discussed in more detail below, in conjunction with the flow chart of FIG. 4, step 220 can be used to select a segment for a visitor V even if this latter segment is not found in the secondary data source 32. For example, at a particular instance, the secondary data source 32 indicates only that visitor V is shopping for a car, but has no other information about him. However, based on visitor's content preference, the profile database 24 indicates that there is a high likelihood that visitor V also owns cats and therefore may like to shop for pet food. Therefore in step 220 the number of segments that may be relevant to visitor V is expanded to include pet products.

In step 222, server 12 identifies first targeted ads or campaigns suitable for visitor V based on the relevant segments. The selection of these ads is narrowed using one or more of the criteria discussed above, with respect to step 210. Thereafter steps 212 and 214 or 216 are followed. Step 216 may also be followed if no appropriate segments are identified in step 220.

As previously discussed, if no information is available from the secondary data source 32, then information from a profile database 24 is used to select the segments corresponding to a visitor V. The information from profile database 24 is derived as follows.

First, as shown in FIG. 4, each time a visitor V is associated with a respective characteristic parameter (such as a musical preference) and additional data is obtained for this visitor from the secondary data source 32, a record for the visitor is established in visitor database 26 (step 102).

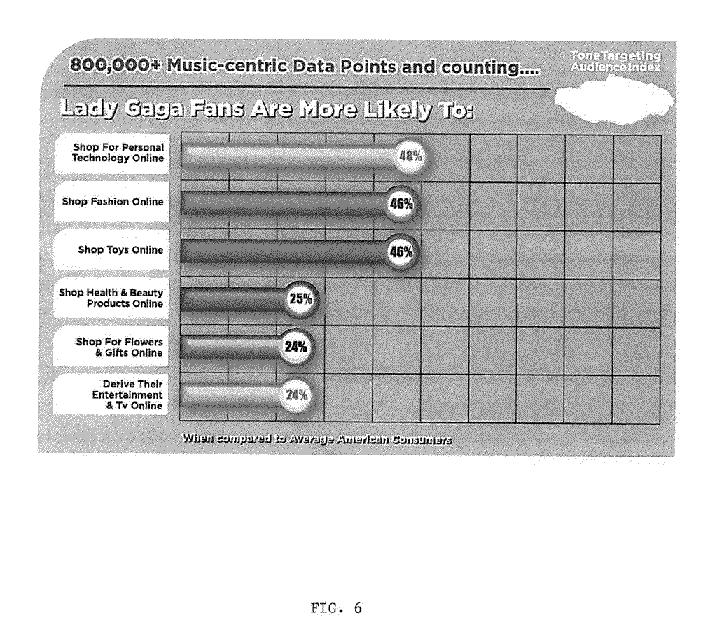

Each record includes the characteristic parameter of the visitor V (e.g., his musical preference) and the information associated with visitor V as received from the secondary data source 32. For various reasons, including privacy considerations, the visitor record preferably does not actually include any personal information about the respective visitor. After a predetermined time, and/or a predetermined number of records are accumulated, profiles are generated in the profile database 24 as described below. These profiles may be recalculated or updated at regular intervals, and/or after another predetermined number of new records have been accumulated in the profile database 24. The profiles are determined as follows. In step 104, the relevant segment for each record is identified. In step 106 an interest index II is calculated by ad server 12 by correlating the characteristic parameter associated with the visitors of universe 62 with the respective information from the secondary data source 32, for each relevant segment, based on the number impressions for a given content preference. For example, as previously mentioned, if the characteristic parameter is musical preference, the resulting profiles in the database 24 are music-centric. FIG. 5 and FIG. 6 show some actual data that are derived from such music centric profiling. As illustrated in FIG. 5, based on information collected by the inventor, fans of Justin Bieber and Lady Gaga (two teenage idols) are more likely to engage in the following activities online as compared to the average American consumer:

| | Bieber |
|---|---|
| Shop Books | 88% |
| Shop Toys | 47% |
| Shop Fashion Accessories | 37% etc. |
| | Lady Gaga |
| Shop Personal Tech | 48% |
| Shop Fashion Accessories | 46% |
| Shop Toys | 46% |

In other words, fans of Lady Gaga are 46% more likely to shop for toys then the average visitor. Preferably, the profiles in profile database in memory 24 are generated by correlating the characteristic parameter of the visitors with the various segments of interest. For example, for a music centric profile database, each interest index II correlates each genre of music, artist and/or song to specific segments using the formula:

II=(ASI/TAI)×(TIA/TSI)×100

Where

ASI=artist's segment impressions (e.g., the number of visitors who like the music of Lady Gaga (or, if the data is available, the number of visitors who like the lyrics of the song “Bad Romance”) and have shopped on line for high fashion items.

TAI=Total artist Impressions

TIA=Total impressions for all artists

TSI=Total segment impressions

Once again, one must keep in mind that the above formula is strictly exemplary and that many other formulas can be used to correlate the characteristic parameter of a visitor with secondary information available only for some of the visitors to evaluate or estimate in some fashion appropriate segments to as many visitors to the content sites as possible, even when there is no corresponding secondary information available from the secondary data source. In step 108 the indexes II thus calculated are stored in database 24 and define a demographic profile for each visitor in set 60.

The indexes II represent profiles based on the characteristic parameters of all the visitors to sites 14-20. When targeted ads are required for a new visitor, in step 222 of FIG. 2, these indexes are analyzed to determine the segments and interests most relevant to the visitor V. For example, if visitor V has Lady Gaga as a musical preference, and more specifically the song, “Bad Romance”, then in step 222 the server 12 may identify all the indexes II based on this song and having a value larger then 100, or between 100 and 120. (It should be understood that these values are merely exemplary and that any other values may be selected for the indexes, based on the requirements of the advertisers, and/or other criteria).

Obviously, the system described above has numerous advantages. One advantage is that the ad server 12 is now capable of providing very narrowly targeted ads to a much larger population of visitors. Moreover, the process for generating the profile database 24 is iterative so that it covers more and more of the population as more visitors visit the content sites.

Another advantage is that the profile database 24 can be transferred (after suitable commercial arrangements are made) to the secondary data source 32 or other similar data sources for use in other systems. In this scenario, the profile database becomes very valuable.

Numerous modifications may be made to the invention without departing from its scope as defined in the appended claims.

I claim:

1. A computer-implemented method of presenting an ad from an ad server to a visitor of a site available from a server comprising the steps of:
determining a characteristic parameter associated with the visitor based on an action of the visitor at said site;
selecting a demographic profile for said visitor based on said characteristic parameter;
selecting by said ad server at least one ad associated with said demographic profile; and
presenting the selected ad to said visitor on said site.

2. The method of claim 1 further comprising correlating information from a plurality of visitors with said characteristic parameter to generate said demographic profile.

3. The method of claim 1 wherein said characteristic parameter is based on the content preferences of said visitor.

4. A method of presenting an ad to the visitor of a site, said visitor having a known characteristic parameter, said method comprising:
detecting the visitor at said site by an ad server;
determining said known characteristic parameter of the visitor by said ad server;
selecting an ad from a plurality of ads for presentation to the visitor based on an interest index relating a potential interest of the visitor to at least one ad segment based on said characteristic parameter;
obtaining said ad; and
presenting said ad to the visitor.

5. The method of claim 4 wherein said interest index is generated by using information related to the interests of other visitors sharing said content characteristic parameter with said visitors,

6. The method of claim 5 further comprising generating a database of demographic profiles for said other visitors based on said behavioral target profiles.

7. The method of claim 4 further comprising monitoring visitors of a plurality of sites by said ad server and generating a profile database associating characteristic parameters of said visitors with their known interests.

8. The method of claim 6 wherein said characteristic profile is based on a content preference of said visitor.

9. A method of generating a database in a machine-readable format, comprising the steps of:
detecting that a plurality of visitors visit a plurality of sites having specific contents;
assigning a characteristic parameter to each said visitor based on said specific content;
obtaining segment specific information about some of said visitors indicating segments of population relevant to said visitor from a secondary source; and
generating profiles correlating at least one segment of population to every visitor of said plurality of said visitors based on the respective characteristic parameters.

10. The method of claim 9 wherein said characteristic parameter is a content preference and said sites provide music-related content

11. The method of claim 9 further comprising calculating an interest index from the number of visitors having a first characteristic parameter and being associated with a first segment to the total number of visitors being associated with said first segment.
